(19) United States
(12) Patent Application Publication
(10) Pub. No.: US 2009/0194566 A1
(43) Pub. Date: Aug. 6, 2009

(54) Moisture Resistant Dispenser for Granular Substances

(76) Inventor: Ruth L. Prager, Brevard, NC (US)

Correspondence Address: RUTH L. PRAGER, POST OFFICE BOX 1668, BREVARD, NC, 28712, US

(21) Appl. No.: 12/025,886

(22) Filed: Feb. 5, 2008

(51) Int. Cl. B67D 5/06; A47G 19/14; B67D 3/00

(52) U.S. Cl. 222/179.5; 222/478; 222/465.1

(57) ABSTRACT

A moisture resistant granular substance dispenser that includes a storage chamber formed from a moisture absorbing material, an aperture within the bottom surface of the chamber for filling and dispensing, and a separate receptacle having a liner, wherein the dispenser is lifted off the receptacle and shaken during use, and wherein the bottom surface of the storage chamber is placed upon and contacts the liner when the dispenser is not in use such that a seal is created between the liner and the bottom surface of said storage chamber and thereby prevents atmospheric moisture from entering into the chamber through the filling and dispensing aperture. The moisture absorbing material used along with the function of the liner reduce the moisture trapped in the chamber and also resist moisture from entering into the chamber.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

This invention relates to dispensers for deliquescent materials that are hygroscopic in nature such as salt, and more particularly, to moisture resistant condiment dispensers.

Prior configurations date back to the turn of the 20^{th} Century. There have been innumerable attempts throughout history to provide a moisture resistant condiment dispenser that is inexpensive to manufacture, functional, attractive and durable. Some of those attempts include designs to isolate the internal chamber of the dispenser to keep atmospheric moisture out including dispensers with hinged lids, various grinder assemblies, sliding tops, and isolated internal chambers. Other designs attempt to ameliorate the moisture problem by absorbing the internal moisture into desiccants suspended in the dispenser. Many of the previously mentioned solutions fall short in many ways including difficulty in filling, difficulty in cleaning, failure to keep hygroscopic materials dry, clogging of exits, difficulty in unclogging exits, expensive to manufacture, and moving parts which eventually break down.

### BRIEF SUMMARY OF THE INVENTION

The purpose of this invention is to significantly improve the usability of a condiment dispenser, reduce internal moisture therein, and resist the entrance of moisture into the dispenser storage chamber. One improvement is the addition of an opening and a stopper within the chamber wall through which the dispenser can easily be filled. Other improvements make the dispenser easier to grip. The main improvement, however, is the addition of a receptacle in which the dispenser rests when not in use that creates a seal between the bottom of the storage chamber and a liner that helps keep moisture from entering a dispensing hole located at the center of the bottom portion of the chamber (as illustrated in the drawings herein). Further, the materials used to construct the body of the dispenser, i.e., unglazed ceramic, function to reduce the moisture content within the chamber.

### BRIEF DESCRIPTION OF THE DRAWINGS

FIG. 1 shows a top plan view of a prior art one-holed salt shaker.

FIG. 2 shows a cross-section elevation view of the prior art of FIG. 1 taken along the line I-I.

FIG. 3 shows a cross section view in perspective of the prior art of FIG. 1 taken along the line I-I.

FIG. 4 shows a top plan view of a first version of the preferred embodiment of the instant invention.

FIG. 5 shows a cross-section elevation view of the first version of the preferred embodiment of the instant invention of FIG. 4 taken along the line II-II.

FIG. 6 shows an exploded cross-section view in perspective of the first version of the preferred embodiment of the instant invention of FIG. 4 taken along the line II-II.

FIG. 7 shows a top plan view of a second version of the preferred embodiment of the instant invention.

FIG. 8 shows a cross-section elevation view of the second version of the preferred embodiment of the instant invention of FIG. 7 taken along the line III-III.

FIG. 9 shows an exploded cross-section view in perspective of the second version of the preferred embodiment of the instant invention of FIG. 7 taken along the line III-III.

### DETAILED DESCRIPTION OF THE INVENTION

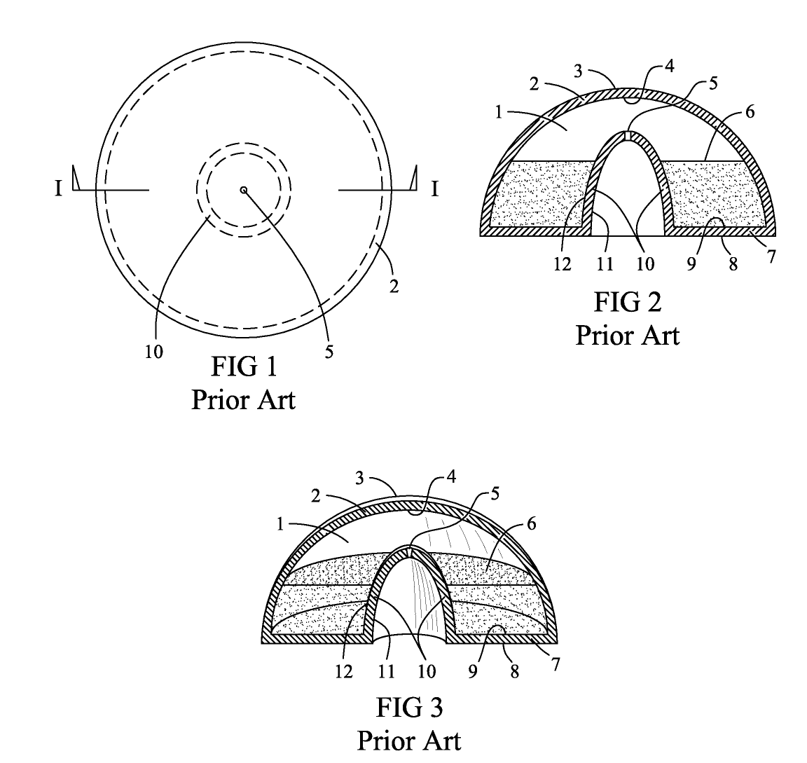

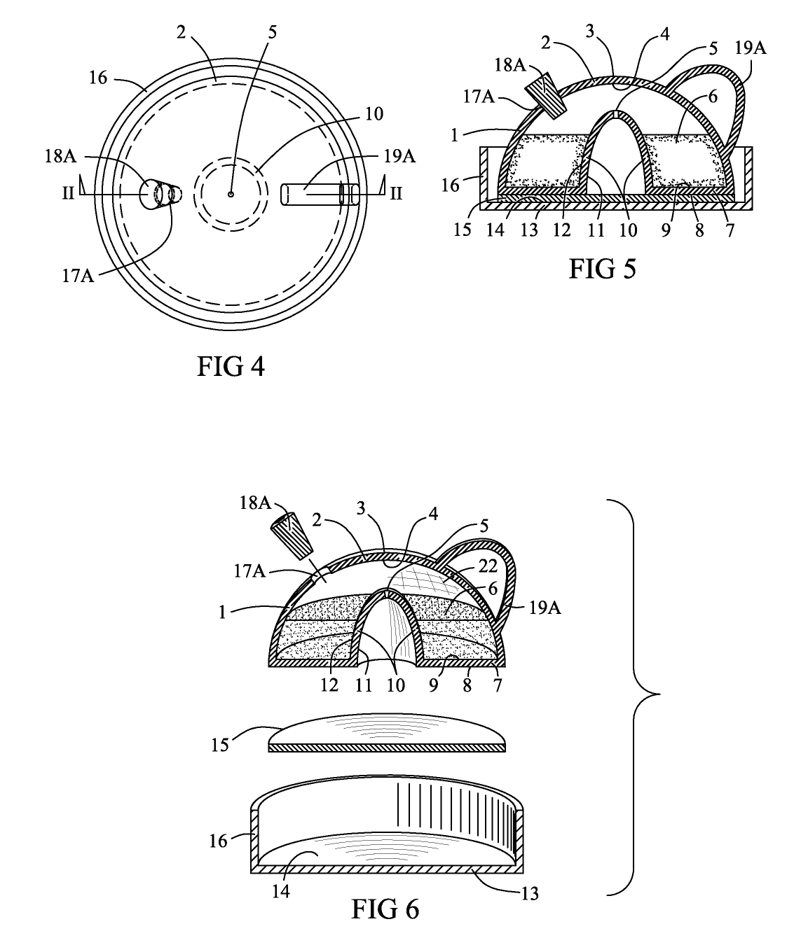

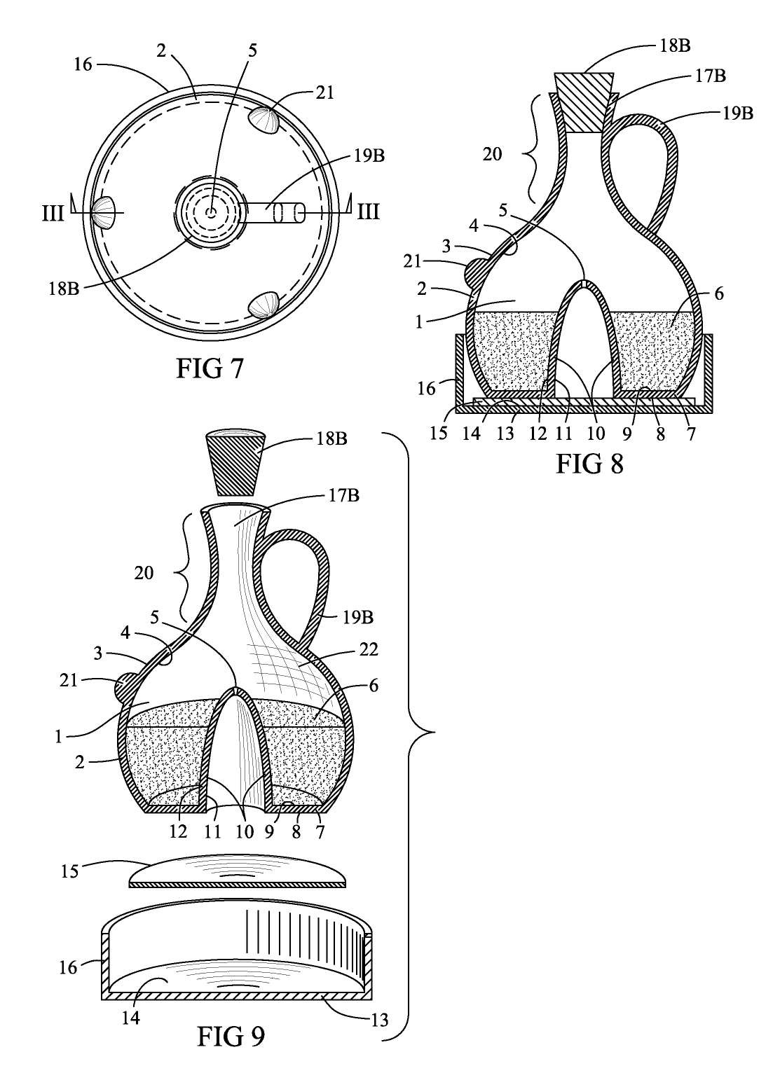

The attributes of the prior art need to be relayed to fully describe the preferred embodiment. The accompanying drawings encompass both the prior art and the preferred embodiments. All features of the prior art as noted in FIGS. 1, 2, and 3 are also present and denoted in FIGS. 4-9 which illustrate two preferred embodiments of the instant invention.

The prior art illustrated in FIGS. 1, 2, and 3 has an internal chamber 1 which is comprised of three surfaces, interior wall 4 of outer dome 2, external wall 12 of inner dome 10 and interior surface 9 of floor 7. Numeral 6 indicates a granular substance as it resides within chamber 1 while the dispenser is at rest. At the apex of inner dome 10 aperture 5 serves as an entrance and exit for granular substance 6. Inner dome 10 has an interior wall 11 which is actually on the outside of the dispenser and is used as a funnel.

The prior art provides for filling the dispenser by inverting the dispenser. While inverted, a granular substance is poured into the funnel comprised of interior wall 11 and aperture 5 of inner dome 10. The granular substance within the funnel steadily passes through aperture 5, entering internal chamber 1. Tapping exterior surface 3 of outer dome 2 facilitates the flow of granular substances into inner chamber 1. This is a slow and tedious process.

Dispensing granular substance 6 is achieved while the dispenser is held in its upright position. The dispenser is jerked upwards causing granular substance 6 to rise above the apex of inner dome 10 and then to fall through aperture 5 exiting the dispenser through the inverted funnel finally falling out underneath the dispenser. As the prior art had no substantial handle, it was difficult to hold and would often slip out of the hand falling into the food.

While at rest the dispenser simply sits upon a surface. Due to the nature of the preferred material, clay, which is used to manufacture the dispenser, moisture can enter the dispenser via unglazed exterior surface 8 of floor 7 and unglazed interior wall 11 of inner dome 10. Additionally moisture can enter internal chamber 1 via aperture 5.

There are two versions of the preferred embodiment, although by relocating and/or changing the size of certain features there are numerous versions that can be achieved. Both versions are made using clay with a high absorption rate. This is important since a significant contribution of this design is that the dispenser itself serves as a desiccant, absorbing moisture away from the granular substance that resides within it.

Referring to FIGS. 4-6 and the first version of the preferred embodiment, handle 19A is affixed to external wall 3 of outer dome 2 enhancing the ability to grip the dispenser. Handle 19A could be located anywhere on external wall 3 of outer dome 2 and take on myriad configurations and forms.

Continuing to refer to FIGS. 4-6, entryway 17A located approximately at the top of outer dome 2 is of sufficient size to provide an open passageway through which the dispenser can easily be filled. Entryway 17A could be located anywhere on outer dome 2 as well as anywhere on floor 7 or inner dome 10. If entryway 17A is located on floor 7 or inner dome 10, the area surrounding the entryway is countersunk. In the case of entryway 17A being located on floor 7, the countersinking is required so that the dispenser can sit flush. In the case of entryway 17A being located on inner dome 10, the countersinking is required to avoid interfering with the dispensing of granular substance 6.

Stopper 18A is inserted into entryway 17A to seal inner chamber 1 away from atmospheric moisture. Stopper 18A can be composed of any number of materials, preferably one that can preclude moisture from entering the dispenser. If entryway 17A is located on floor 7 or inner dome 10, the stopper should be flush with the surface of the dispenser within the countersink for the reasons stated in the previous paragraph.

The final improvement in the first version of the preferred embodiment is a receptacle in which said dispenser rests when not in use. The receptacle is comprised of a floor 13, an interior surface 14 of said floor 13, a liner 15 affixed to interior surface 14 and a surrounding wall 16. Interior surface 14 of the receptacle with liner 15 provides a surface that will meet with bottom 8 of the dispenser. The contact between exterior surface 8 of the dispenser and liner 15 of the receptacle provides a seal, keeping atmospheric moisture from entering internal chamber 1 of the dispenser via external surface 8, interior wall 11 or aperture 5.

Referring to FIGS. 7-9, and the second version of the preferred embodiment, elongated neck 20 provides an open entryway 17B through which the dispenser can be conveniently filled. Neck 20 is also a means to easily grip the dispenser, acting as a handle which in turn prevents the dispenser from being dropped. Handle 19B could be located anywhere on external wall 3 of outer dome 2 and take on myriad configurations and forms. This improvement can also take the form of several strategically placed protuberances 21 adhered to exterior wall 3 of outer dome 2.

The stopper indicated by lead line 18B inserted into the top of said neck 20 serves to isolate chamber 1 from atmospheric moisture thus facilitating the desired moisture resistant quality of this embodiment.

The receptacle is also used in conjunction with the second version of the preferred embodiment. FIGS. 7-9 denote all aspects of the receptacle previously described.

The dispenser with its preferred embodiments is used in the following manner. Fill the dispenser while in the upright position by inserting a finger into inner dome 10 thus blocking aperture 5 thereby keeping the granular substance from passing straight through the dispenser and out the bottom. Remove stopper 18A/18B and pour the granular substance into entryway 17A/17B. The level of granular substance 6 within chamber 1 should not be higher than aperture 5. Overfilling the dispenser will cause the granular substance to freely flow out of the dispenser until the level of the granular substance is below aperture 5. After filling the dispenser, reinsert cork 18A/18B into entryway 17A/17B. Place the dispenser in the receptacle when not in use. Dispensing granular substance 6 is achieved in the same manner as the prior art as described previously with the added advantage of the handle of the preferred embodiments.

The methods of constructing the invention are many and varied. One such method of construction is to throw it on a potter's wheel. A ball of clay is centered on the head of a potter's wheel or other throwing surface. The clay is flattened to a certain extent and is then opened to the throwing surface. The patty of clay is then divided by separating an amount of clay to be pulled up and coned in forming inner cone 10. Inner cone 10 should be of such size as to allow a finger to be inserted during the process of filling the dispenser. Once the internal cone is formed the remainder of the patty of clay is pulled out a little further and then pulled up and coned in, creating outer dome 2. This exterior wall can be finished as either dome 2 of the two preferred embodiments with entryway 17A or outer dome 2 with elongated neck 20 and entryway 17B. In either case the entryway should be wide enough to permit easy passage of the granular substance when filling the dispenser and of a size in which a specified stopper can snuggly fit. Once the dispenser is leather hard and separated from its throwing surface, the bottom should be cleaned up and burnished. A drill of sufficient size is inserted into inner dome 10 and used to open aperture 5 to a sufficient size that permits the passing of granular substance 6. At this point handle 19A can be made and affixed to the dispenser. If the option of affixing protuberances rather than a handle is chosen, this is the point at which they would be affixed to outer dome 2. Once completely dry the dispenser is taken through the bisque firing and then the glazing and glaze firing processes. It should be noted that the inside 22 of the dispenser shown in FIGS. 9 and 6 must not be glazed. The unglazed internal surfaces 4, 9, and 12 assist in the moisture resistant properties of the dispenser in that the clay will absorb moisture away from the salt should moisture enter chamber 1.

The receptacle for the dispenser likewise can be constructed using varying techniques. One such technique is throwing it on the potter's wheel. A ball of clay is centered on the head of a potter's wheel or other throwing surface. The centered clay is then opened to such a width as to accommodate the dispenser that will reside within it, remembering that clay shrinks during the drying and firing processes. Wall 16 is pulled up to create the receptacle. Once the receptacle is leather hard it should be removed from the throwing surface and the bottom burnished or trimmed. Once completely dry the receptacle is taken through the bisque firing and then the glazing and glaze firing processes. Lastly, a pad of cork or other appropriate material should be adhered to interior surface 14 of the receptacle and a stopper inserted into entryway 17A/17B.

I claim:

1. A moisture resistant granular substance dispenser comprising:
a storage chamber including a bottom surface and an aperture within the bottom surface for filling and dispensing a granular substance;
and a receptacle having a flat floor surface, and a liner affixed to the upper surface of the floor surface;
wherein the bottom surface of the storage chamber is placed upon and contacts the liner when the dispenser is not in use such that a seal is created between the liner and the bottom surface of said storage chamber and thereby prevents atmospheric moisture from entering into the chamber.

2. The dispenser as set forth in claim 1, wherein the receptacle includes side surfaces extending upwards from the edges of said floor surface.

3. The dispenser as set forth in claim 1, wherein said chamber is formed from a material that absorbs moisture from the air within the chamber.

4. The dispenser as set forth in claim 3, wherein said material is clay.

5. The dispenser as set forth in claim 3, wherein said material is ceramic, wherein said ceramic material is glazed only on the outer surface of the chamber and not on the inner surface.

6. The dispenser as set forth in claim 1, wherein the chamber includes a dome that is
inwardly protruding from the bottom surface;
and wherein said aperture is positioned on the apex of the dome;
such that when the dispenser is upside down the dome acts as a funnel for use when filling the chamber with a granular substance, and for when the dispenser is upright and shaken the granular substances can be dispensed back through the aperture.

7. The dispenser as set forth in claim 1, wherein said liner is formed from a supple material that is capable of forming a hermetic seal with the bottom surface of said storage chamber.

8. The dispenser as set forth in claim 7, wherein said supple material is chosen from a group of material including rubber and cork.

9. A moisture resistant granular substance dispenser comprising:
a storage chamber including a bottom surface, an aperture within the bottom surface for dispensing a granular substance, a hole within the wall of the upper half of the chamber for filling the chamber with a granular substance, and a stopper for placing within the hole to hermetically seal the hole;
and a receptacle having a flat floor surface, and a liner affixed to the upper surface of the floor surface;
wherein the bottom surface of the storage chamber is placed upon and contacts the liner when the dispenser is not in use such that a seal is created between the liner and the bottom surface of said storage chamber and thereby prevents atmospheric moisture from entering into the chamber.

10. The dispenser as set forth in claim 9, wherein the receptacle includes side surfaces extending upwards from the edges of said floor surface.

11. The dispenser as set forth in claim 9, wherein said chamber is formed from a material that absorbs moisture from the air within the chamber.

12. The dispenser as set forth in claim 11, wherein said material is clay.

13. The dispenser as set forth in claim 11, wherein said material is ceramic.

14. The dispenser as set forth in claim 9, wherein the chamber includes
a dome that is inwardly protruding from the bottom surface;
and wherein said aperture is positioned on the apex of the dome;
such that when the dispenser is upside down the dome acts as a funnel for use when filling the chamber with a granular substance, and for when the dispenser is upright and shaken the granular substances can be dispensed back through the aperture.

15. The dispenser as set forth in claim 9, including
an elongated neck extending upwards from said hole, such that a granular substance can be more easily poured into the chamber through the neck and hole; and wherein the stopper can be placed at any point along the interior of the neck, including at the point where it meets the hole.

16. The dispenser as set forth in claim 15, wherein
the outer wall of the chamber includes a plurality of protrusions, thereby increasing a user's ability to grip and hold the dispenser.

17. The dispenser as set forth in claim 16, wherein
the outer wall of the chamber further includes a handle, thereby increasing a user's ability to grip and hold the dispenser.

18. A moisture resistant granular substance dispenser comprising:
a storage chamber formed from a material that absorbs moisture from the air within the chamber;
said storage chamber further including a hole within the wall of the upper half of the chamber for filling and dispensing a granular substance to and from the storage chamber;
and a removable stopper for placing within the hole to hermetically seal the hole when not in use.

19. The dispenser as set forth in claim 18, wherein said material is ceramic.

20. The dispenser as set forth in claim 19, wherein said ceramic material is only glazed on the outer surface of the chamber and not on the inner surface of the chamber.
